(19) United States
(12) Patent Application Publication
(10) Pub. No.: US 2012/0284729 A1
(43) Pub. Date: Nov. 8, 2012

(54) PROCESSOR STATE-BASED THREAD SCHEDULING

(75) Inventors: Vishal Sharda, Redmond, WA (US); Bruce L. Worthington, Redmond, WA (US)

(73) Assignee: MICROSOFT CORPORATION, Redmond, WA (US)

(21) Appl. No.: 13/099,660

(22) Filed: May 3, 2011

(51) Int. Cl. G06F 9/46

(52) U.S. Cl. 718/104

(57) ABSTRACT

Techniques for implementing processor state-based thread scheduling are described that improve processor performance or energy efficiency of a computing device. In one or more embodiments, a power configuration state of a processor is ascertained. The processor or another processor is selected to execute a thread based on the power configuration state of the processor. In other embodiments, power configuration states of processor cores are ascertained. Power configuration state criteria for the processor cores are defined based on the respective power configuration states. One of the processor cores is then selected based on the power configuration state criteria to execute a thread.

### BACKGROUND

Processors of computing devices often support various configuration states that allow operating characteristics of a processor to be managed and/or adjusted. An operating system can manage these configuration states, such as performance states and/or idle states, to attain higher energy efficiency and/or improved performance while executing software threads on the device. The advantages provided by each of these configuration states, however, have inherent costs in terms of latency and/or power when a processor unnecessarily transitions between states and/or remains in certain states.

For example, a processor in a high performance state may quickly execute a thread at the cost of increased energy consumption during periods of inactivity. Conversely, a processor in a low performance state may conserve energy at the cost of additional latency and energy associated with transitioning the processor to and from a thread-executable state. Threads of software processes or tasks are typically assigned to a processor by a thread scheduler that does not account for these processor configuration states. Scheduling a thread for execution without accounting for the configuration state of the processor can result in performance degradation and/or excessive energy consumption as the processor changes states to reach a thread-executable state or remains in a thread-executable state during periods of inactivity.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In one or more embodiments, a power configuration state associated with a processor eligible to execute a thread is ascertained. The thread is then scheduled for execution on the processor or another processor based on the power configuration state of the processor.

In other embodiments, power configuration states of two or more processor cores are ascertained. Power configuration state criteria are defined for the two or more processors based on a respective power configuration state of each processor core. One of the processor cores is then selected to execute the thread based on the power configuration state criteria.

In yet other embodiments, characteristics of a power policy and a power configuration state of a processor are ascertained. A thread is then scheduled for execution on the processor or another processor based on the power configuration state and the characteristics of the power policy.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 illustrates an example environment in accordance with one or more embodiments.

FIG. 2 illustrates an example processor of FIG. 1 in accordance with one or more embodiments.

FIG. 3 illustrates example processors of FIG. 1 in accordance with one or more embodiments.

FIG. 4 is a flow diagram that illustrates steps in a method in accordance with one or more embodiments.

FIG. 5 is a flow diagram that illustrates steps in a method in accordance with one or more embodiments.

FIG. 6 is a flow diagram that illustrates steps in a method in accordance with one or more embodiments.

### DETAILED DESCRIPTION

### Overview

In one or more embodiments, a power configuration state associated with a processor eligible to execute a thread is ascertained. The thread is then scheduled for execution on the processor or another processor based on the power configuration state of the processor.

In other embodiments, power configuration states of two or more processor cores are ascertained. Power configuration state criteria are defined for the two or more processors based on the respective power configuration state of each processor core. One of the processor cores is then selected to execute the thread based on the power configuration state criteria.

In yet other embodiments, characteristics of a power policy and a power configuration state of a processor are ascertained. A thread is then scheduled for execution on the processor or another processor based on the power configuration state and the characteristics of the power policy.

In the discussion that follows, a section titled “Operating Environment” is provided and describes one environment in which one or more embodiments can be employed. Following this, a section titled “Example Processors” describes example processors and configuration states in accordance with one or more embodiments. Next, a section titled “Thread Characteristics” describes example characteristics of threads in accordance with one or more embodiments. Last, a section titled “Example Methods” describes example techniques and methods in accordance with one or more embodiments.

Operating Environment

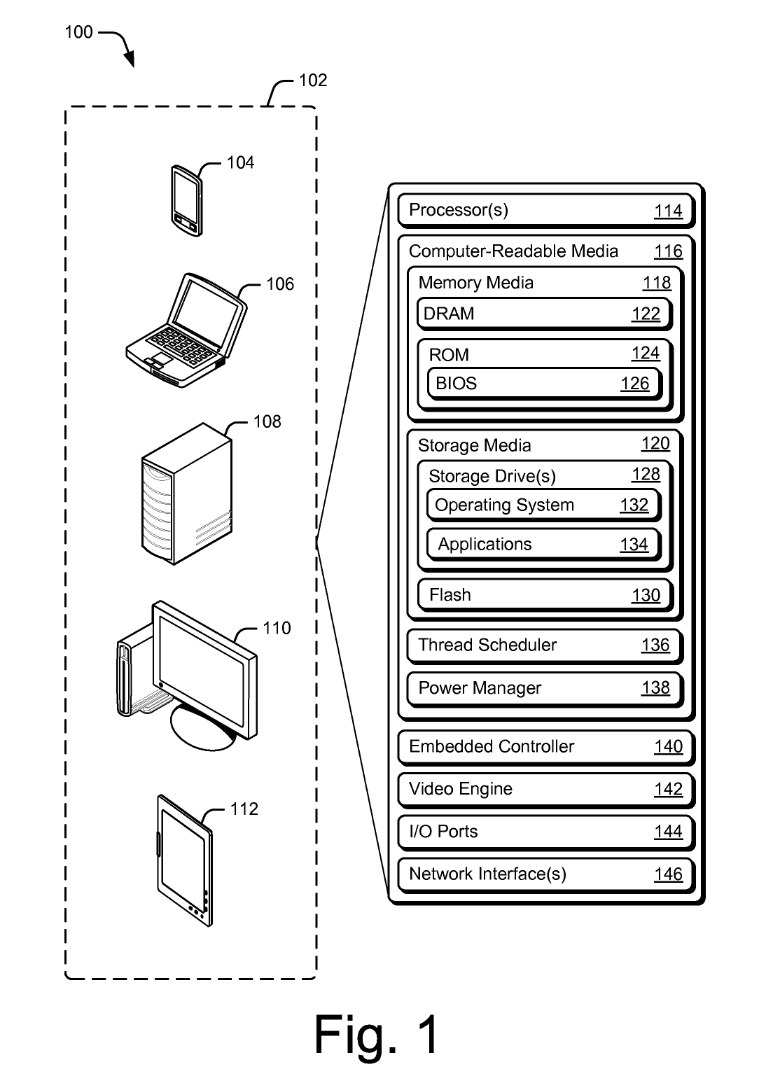

FIG. 1 illustrates an operating environment in accordance with one or more embodiments, generally at 100. Environment 100 includes computing devices 102, each of which are capable of executing software to operate and/or provide functionality. Computing devices 102 are representative of one or more systems and/or devices that may implement the various embodiments described below. In this particular example, computing devices 102 can include, by way of example and not limitation, smart-phone 104, laptop computer 106, server 108, desktop computer 110, and tablet computer 112. In the illustrated and described embodiments, computing devices 102 can implement and execute any suitable firmware and/or software platform, programs, applications, operating systems and the like.

Each computing device 102 includes processor(s) 114 and computer-readable memory 116. Processor(s) 114 can be any suitable processor or processors and are described in more detail in the following sections. Computer-readable media 116 may be configured to store data and computer-executable instructions associated with software executing on computer device 102. Computer-readable media 116 may comprise any suitable type of media such as memory media 118 and/or storage media 120, and the like. In at least some embodiments, memory media 118 can include dynamic-random-access memory (DRAM) 122 and/or read-only memory (ROM) 124.

Although illustrated as ROM 124, memory media 118 may include other forms of non-volatile memory including non-volatile RAM (NVRAM), programmable ROM (PROM), electronically-erasable PROM (EEPROM), and the like. In at least some cases, processor-executable instructions of basic input/output system (BIOS) 126 can be maintained on ROM 126 or another type of non-volatile memory. Alternately or additionally, in at least some embodiments, ROM 124 may maintain other computer-executable instructions or code such as a boot-loader code, source code, or other low-level code executed at system boot-up.

In at least some embodiments, storage media 120 of computing devices 102 may include storage drive(s) 128 and/or flash 130. Storage drive(s) 128 can comprise any suitable type of storage drive, such as a hard disk drive, a solid state drive, a flash memory drive, a universal serial bus (USB) storage drive and the like. Flash 130 can be configured any suitable way, such as on-board chips, removable cards, embedded modules, and the like. In some instances, operating system (OS) 132 and/or applications 134 can be stored on storage drives 128. Alternately or additionally, in other instances, OS 132 or applications 134 may be stored on flash 130, such as when computing device 102 is configured without a storage drive 130.

In at least some embodiments, OS 132 can be an embedded or mobile operating system, such as an operating system capable of operating on a reduced-instruction set computer (RISC) processor. For example, smart-phone 104 may implement a mobile operating system that operates on an RISC processor (e.g. advance RISC machine (ARM) processor). In such a case, applications 134 may be embedded or mobile applications configured operate with the embedded or mobile OS.

In at least some other embodiments, OS 132 can be a 32-bit or 64-bit operating system capable of operating on or being executed by a processor, such as, by way of example and not limitation, an IA-32 or x86-64 processor. For example laptop computer 106 may implement a 64-bit operating system that operates on an x86-64 processor. In such a case, applications 134 may be configured to operate or execute as a 32-bit or a 64-bit application within the 64-bit operating system.

In at least some embodiments, tasks or processes of OS 132, applications 134, or other software components of computing device 102 comprise threads (not shown) that may be executed by processor(s) 114. In some instances, the tasks and processes are separated into one or more threads for serial or parallel execution by processor(s) 114. Thread scheduler 136 can schedule threads for execution on processor(s) 114 as described in more detail in the following sections.

Alternately or additionally, in at least some embodiments, the computing device may include power manager 138 to manage power and/or performance characteristics of computing device 102. In at least some embodiments, power manager 138 can be implemented as part of or a component of OS 132. In some cases, power manager 138 can configure various software or hardware components to affect energy efficiency and/or performance capabilities of computing device 102. In such a case, power manager 138 may configure the various software or hardware components in accordance with a power policy or power profile governing performance characteristics and/or energy efficiency of computing device 102.

In at least some embodiments, computing device 102 may also include embedded controller (EC) 140 for managing or providing low-level system functions. In at least some embodiments, embedded controller 140 can manage low-level system functions related to system power, clocking signals, thermal solutions, generic input/output, diagnostics, power-up configuration, power-on-self-test (POST), and the like. For example, an embedded controller 140 of laptop computer 106 may manage power supplies, enable battery charge circuitry, control and monitor cooling fans, adjust display brightness backlight, and so on.

Computing device 102 may also include video engine 142 for processing and rendering graphical information. In at least some instances, video engine 142 can process user interface elements of OS 132, application 134, or other software components for transmission to a local, external or remote display operable associated with computing device 102. For example, video engine 142 of laptop 106 can provide graphical information to multiple displays, such as an internal liquid crystal display (LCD) of laptop 106 and an external LCD monitor (not shown) operably coupled with laptop 106 via any suitable means.

Alternately or additionally, in at least some embodiments, computing device 102 includes Input/Output (I/O) ports 144 for interacting with other devices or users. I/O ports 144 can include any suitable type of port, such as audio ports, USB ports, serial advanced technology attachment (SATA) ports, peripheral component interconnect (PCI) express based ports or card slots, serial ports, parallel ports, or other legacy ports.

In at least some embodiments, computing device 102 can include network interface(s) 146 for communicating data via various networks. Network interface 146 may communicate via any suitable type of network including, by way of example and not limitation, a local-area-network (LAN), a wireless local-area-network (WLAN), a personal-area-network (PAN), a wide-area-network (WAN), an intranet, the Internet, a peer-to-peer network, point-to-point network, a mesh network, and so on. Alternately or additionally, in at least some embodiments, network interface 146 may support communication in accordance with a specification or standard associated with a network, such as the Institute of Electrical and Electronic Engineers (IEEE) 802.3 standard for an Ethernet based LAN communication or the IEEE802.11 standard for WLAN communication.

Having considered an example operating environment, consider now one or more processors which can be implemented in a computing device of the operating environment described above.

Example Processors

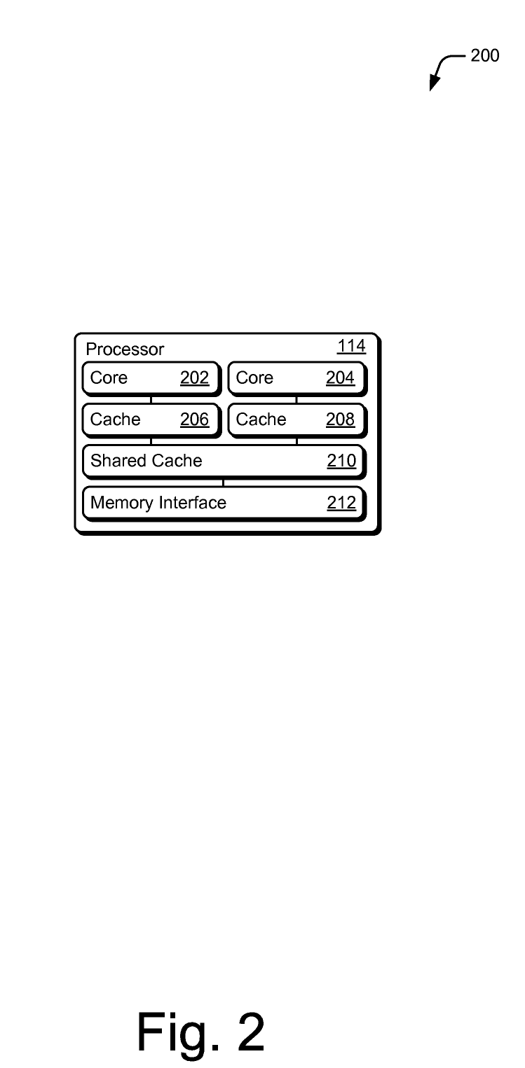

FIG. 2 illustrates an example processor 114 in accordance with one or more embodiments, generally at 200. In this example, processor 114 includes two processor cores 202, 204 for executing threads. In at least some embodiments, threads are scheduled for execution on cores 202, 204 by thread scheduler 136 (FIG. 1) in accordance with one or more techniques described in the following sections. Cores 202, 204 can comprise any suitable type of processing core, such as an ARM core, an IA-32 core, an x86-64 core and so on. Additionally, although illustrated as a dual core processor, processor 114 may include any suitable number of cores or be operably coupled with one or more additional processors.

In at least some embodiments, processor 114 may include caches 206, 208 (e.g. Level 1 (L1) cache) associated with cores 202, 204 respectively. Alternately or additionally, in at least some embodiments, processor 114 may include shared cache 210 (e.g. Level 2 (L2) cache) associated with and accessible by both cores 202, 204. In at least some embodiments, processor 114 includes memory interface 212 for communicating data with other memories of computing device 102. For example, processor 114 may communicate data with DRAM 122 or another processor operably coupled to a front-side-bus (FSB) (not shown) or point-to-point interconnect (not shown) coupling one or more processors and DRAM 122.

Cores 202, 204, and respective components associated therewith may be configured any suitable way at a system level, board level, package level, die level, and so on. In some cases, cores 202, 204 can be implemented on a common die sharing some or all resources available to either core. In other cases, cores 202, 204 can be implemented on different dies yet be placed on a common package. It is to be appreciated and understood, however, that other processor or core configurations can be utilized in connection with the principles described herein.

Generally, operating characteristics of cores 202, 204 can include an operating frequency or an operating voltage which may affect energy consumption and/or thread processing performance of processor 114. Additionally, a core may include an inherent capacitance associated with internal processor circuitry, such as transistor gates and the like. As illustrated by Equation 1 below, varying either or both of the voltage and the frequency of a core may affect an amount of energy consumed while processing or executing threads.

Power=Capacitance×(Voltage)×Frequency Equation 1.

In at least some of embodiments, operating characteristics of cores 202, 204 can be substantially similar or dependent on a shared frequency plane or voltage plane. In some cases, cores 202, 204 implemented on a common package or die can share a common frequency plane or common voltage plane. In other cases, cores 202, 204 implemented on a common package or die can have unique or separately variable operating characteristics.

Operating characteristics of cores 202, 204 may be adjusted by setting a configuration state associated with cores 202, 204. In at least some embodiments, a configuration state includes a power configuration state that can affect power consumption of a processor or a core. In some cases, a power configuration state can adjust a frequency and/or a voltage of a core individually. In other cases, a power configuration state can adjust a frequency and/or a voltage of cores 202, 204 jointly. In at least some embodiments, setting a power configuration state associated with a processor core may adjust a clock generation integrated circuit (IC) or a power supply circuit operably associated with the processor core. For example, setting a power configuration state for processor 114 can cause a clock generation IC to decrease a frequency of a clocking signal transmitted to cores 202, 204.

Alternately or additionally, in at least some embodiments, cores 202, 204 may have one or more power configuration states capable of adjusting operating characteristics of a respective core. In some cases, an idle configuration state may adjust operating characteristics of a core to allow the core to idle or sleep when inactive or not executing threads. In at least some embodiments, one or more idle configuration states may adjust an operating frequency and/or operating voltage of a core to conserve energy. In some instances, moving to different idle configuration states may reduce an operating frequency and/or operating voltage of a core conserving energy. In at least some embodiments, a core in an idle configuration state can exit the idle configuration state to reach a thread-executable state. In such a case, a core may transition to a shallower idle configuration state or a non-idle configuration state to execute the thread ready for execution.

Alternately or additionally, in at least some embodiments, one or more idle configuration states may be defined or implemented in accordance with a specification, such as the Advance Power and Configuration Interface (ACPI) specification. For example, one or more idle configuration states may correspond to one or more C-states as defined by the ACPI specification, such as C0 (core at fully active state) or another C-state defining a deeper sleep state (e.g. C1, C2, . . . , Cn, each C-state defining progressively deeper sleep/idle states).

Alternately or additionally, in at least some embodiments, a performance configuration state may adjust operating characteristics of a core increasing or decreasing thread processing performance of the core in accordance with performance limits or criteria (e.g. user profile or power policy). In at least some embodiments, one or more performance configuration states may adjust an operating frequency and/or operating voltage of a core to improve processor performance. In some instances, moving to different performance configuration states may increase an operating frequency and/or operating voltage of a core to improve thread processing performance.

Alternately or additionally, in at least some embodiments, one or more performance configuration states may be defined or implemented in accordance with a specification, such as the ACPI specification. For example, one or more performance configuration states may correspond to one or more P-state as defined by the ACPI, such as P0 (maximum performance) or another P-state defining a lower performance state (e.g. P1 having scaled down core voltage/frequency parameters).

Power configuration states associated with cores 202, 204 may be defined at various levels of processing granularity, such as at a package level, a processor level, a die level, a core level, a hardware thread level (e.g. Intel Hyper-Threads), and so on. In at least some embodiments, a power configuration state associated with a higher level of processing granularity may depend on one or more power configuration states associated with lower levels of processing granularity. In the context of the present example, an idle configuration state associated with processor 114 including cores 202, 204 may depend on idle configuration states associated with cores 202, 204. In such a case, an idle configuration state of processor 114 may correspond to the shallowest (lowest) idle configuration state associated with cores 202, 204. Table 1 below illustrates some example power configuration states of processor 114 and cores 202, 204.

TABLE 1
Processor Configuration State

| | Idle | Performance | | Idle | Performance |
|---|---|---|---|---|---|
| Processor | State | State | Core | State | State |
| Processor 114 | 2 | 1 | Core 202 | 2 | 1 |
| | | | Core 204 | 3 | 1 |

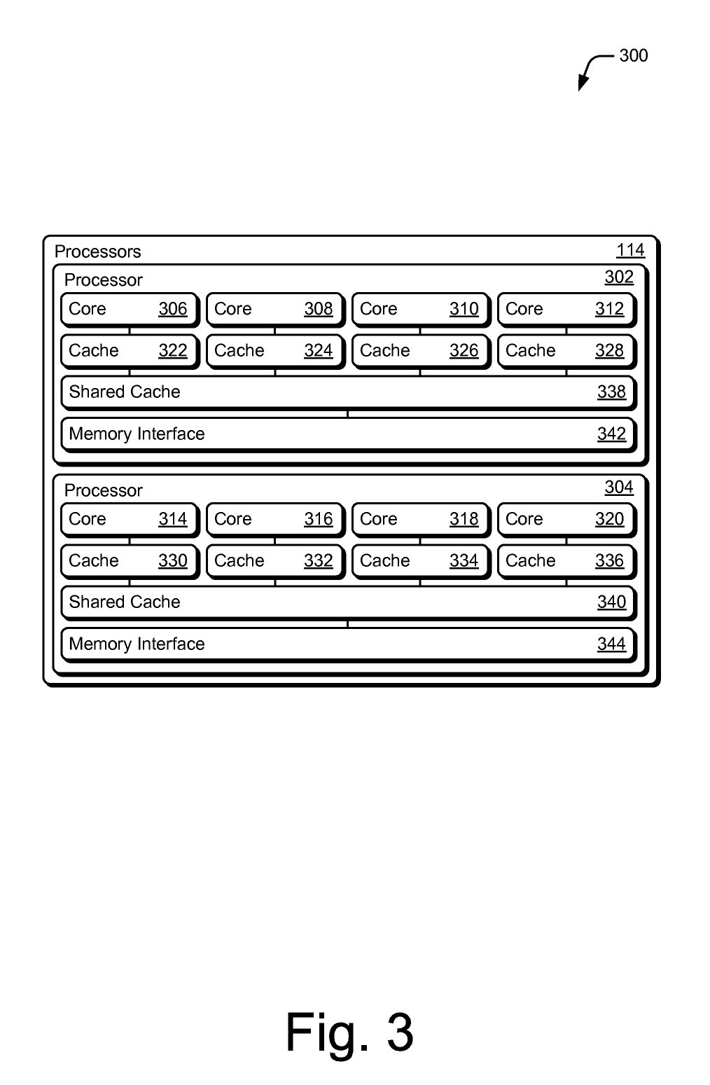

Next consider FIG. 3 which illustrates another example of processors 114 in accordance with one or more embodiments, generally at 300. In this example, processors 114 include processor 302 and processor 304 for executing threads which may be any suitable type of processors, such as ARM processors, IA-32 processors, x86-64 processors and so on. Additionally, although illustrated as two similar multi-core processors, processors 114 may include any suitable number of single-core or multi-core processors.

In at least some embodiments, processors 302, 304 may include cores 306-312 and cores 314-320 respectively for processing software threads. Alternately or additionally, in at least some embodiments, processors 302, 304 may include caches 332-328 or caches 330-336 respectively, associated with and accessible by a respective core. In some cases, processors 302, 304 may include shared cache 338, 340 respectively, associated with and accessible by any core of a respective processor. Cores 306-312 and cores 314-320, including respective caches associated therewith, may be grouped in any suitable way, such as sets of cores or subsets of cores on a per package or per die basis. Alternately or additionally, in at least some embodiments, processors 302, 304 and cores 306-312 may be grouped and associated with one or more memories (e.g. caches, shared cache, or system memory) as non-uniform memory access (NUMA) nodes.

In at least some embodiments, processors 302, 304 may include respective memory interfaces 342, 344 for communicating data with other memories of computing device 102. For example, processor 302 may communicate data with processor 304, DRAM 122, or other processors operably coupled to a front-side-bus (FSB) (not shown) or point-to-point interconnect (not shown) coupling one or more processors and DRAM 122.

Processors 302, 304, and respective components associated therewith, may be configured any suitable way at a system level, board level, package level, die level, and so on. In some cases, processors 302, 304 can be implemented on a common die or a common package sharing some or all resources available to the cores. In other cases, processors 302, 304 can be implemented on different processor packages on a common board with dedicated resources for each processor package. It is to be appreciated and understood, however, that other processor or core configurations can be utilized in connection with the principles described herein.

Generally, as described above, operating characteristics of processors 302, 304, and their respective cores can include an operating frequency and/or an operating voltage which may affect energy consumption of processors 114. In at least some of embodiments, operating characteristics of cores 306-312 or 314-320 can be substantially similar or dependent on a shared frequency plane or voltage plane. In some cases, cores 306-312 or 314-320 implemented on a common package or die can share a common frequency plane or common voltage plane. In other cases, cores 306-312 or 314-320 implemented on a common package or die can have unique or separately variable operating characteristics.

Operating characteristics of cores 306-320 may be adjusted by setting a configuration state associated with cores 306-320. In at least some embodiments, a configuration state includes a power configuration state that can affect power consumption of a processor or a core. In some cases, a power configuration state can adjust a frequency and/or a voltage of a core individually. In other cases, a power configuration state can adjust a frequency and/or a voltage of cores 306-312 and/or 314-320 jointly. Alternately or additionally, in at least some embodiments, cores 202, 204 may have one or more power configuration states capable of adjusting operating characteristics of a respective core.

As discussed above, in at least some embodiments, an idle configuration state may adjust operating characteristics of a core to allow the core to idle or sleep when inactive or not executing threads. Alternately or additionally, in at least some embodiments, a performance configuration state may adjust operating characteristics of a core increasing or decreasing thread processing performance of the core in accordance with performance limits or criteria (e.g. user profile or power policy). In at least some embodiments, these power configuration states can be defined or implemented in accordance with a specification, such as the ACPI specification as described above.

Power configuration states associated with processors 302, 304 may be defined at various levels of processing granularity, such as at a package level, a processor level, a die level, a core level, and so on. Accordingly, a core may be associated with one or more power configuration states at a core level, a die level, a package level and so on. For example, power configuration states, such as any suitable ACPI states, can be defined for processors 302, 304 or cores 306-320. Table 2 below illustrates some example ACPI states of processors 302, 304.

TABLE 2
Processor ACPI States

| | Idle | Performance | | Idle | Performance |
|---|---|---|---|---|---|
| Processor | State | State | Core | State | State |
| Processor 302 | C0 | P0 | Core 306 | C0 | P0 |
| | | | Core 308 | C0 | P0 |
| | | | Core 310 | C2 | P1 |
| | | | Core 312 | C2 | P1 |
| Processor 304 | C4 | P2 | Core 314 | C4 | P2 |
| | | | Core 316 | C4 | P2 |
| | | | Core 318 | C6 | P2 |
| | | | Core 320 | C6 | P2 |

Having considered various processor configurations, consider now various thread characteristics in accordance with one or more embodiments.

Thread Characteristics

The discussion that follows describes characteristics of threads executable by one or more processors described in the previous sections. In at least some embodiments, these thread characteristics can be considered when scheduling a thread for execution by a processor core. For example, a decision for scheduling a thread on a processor can be based on a thread characteristic. Alternately or additionally, in at least some embodiments, a power configuration state can be considered when scheduling a thread for execution by a processor core. For example, a decision for scheduling a thread on a processor can be based on an idle or performance configuration state of the processor or another candidate processor.

In at least some embodiments, a priority level of a thread may be considered when scheduling the thread for execution. For example, a thread with a high priority level may be scheduled for execution on a core in a high performance configuration state or shallow idle configuration state for faster execution. Alternately a thread with a low priority level may be scheduled for execution on a core with a low performance configuration state or deep idle configuration state to conserve energy by precluding a processor in a high performance configuration state from executing the thread.

An average or expected runtime of a thread can also be considered when scheduling a thread for execution. In some cases, a thread having a long expected runtime can be scheduled for execution on a processor or core having a high performance configuration state to improve performance and/or shorten runtime. In other cases, a thread having a short expected runtime can be scheduled for execution on a processor having a low performance configuration state without significantly impacting performance.

In at least some embodiments, an average wait time or a previous execution delay of a thread can be considered when scheduling a thread for execution. For example, a thread with a high average wait time can be scheduled for execution on a processor or core having a high performance configuration state to improve performance and/or reduce the average wait time of the thread. Alternately or additionally, in at least some embodiments, a history or preference of a thread for executing on a package, processor, or core can be considered when scheduling a thread for execution. In some instances, a thread with a history of executing on a core can be scheduled for execution on that core to leverage possible cache benefits when data associated with the thread remains in a cache associated with that core.

In at least some embodiments, a thread may be characterized as memory-bound or processor-bound. A memory-bound thread may have a workload that is memory constrained, that is, a significant quantity of data associated with the thread may need to be fetched from system memory. In some cases, a memory-bound thread may be scheduled on a processor with a low performance configuration state without affecting performance. Alternately, a processor-bound thread may have a workload that is processor constrained, that is, a significant quantity of data associated with the thread may be accessed from the processor cache. In some cases, a processor-bound thread may be scheduled on a processor with a high performance configuration state to further improve performance.

In a case where a thread has not been previously scheduled for execution on a core or processor, an associated cache may have to load data associated with the thread from memory and/or caches not associated with the core or processor. This “warming up” of the cache may cause the thread to be temporarily memory-bound. In such a case, the thread may be scheduled on a processor having a low performance configuration state until the cache is “warm,” at which point the performance configuration state can be raised to a higher level to execute the thread at a higher performance level. Having considered example thread characteristics, consider now one or more methods that may be implemented with the computing devices described above and below.

Example Methods

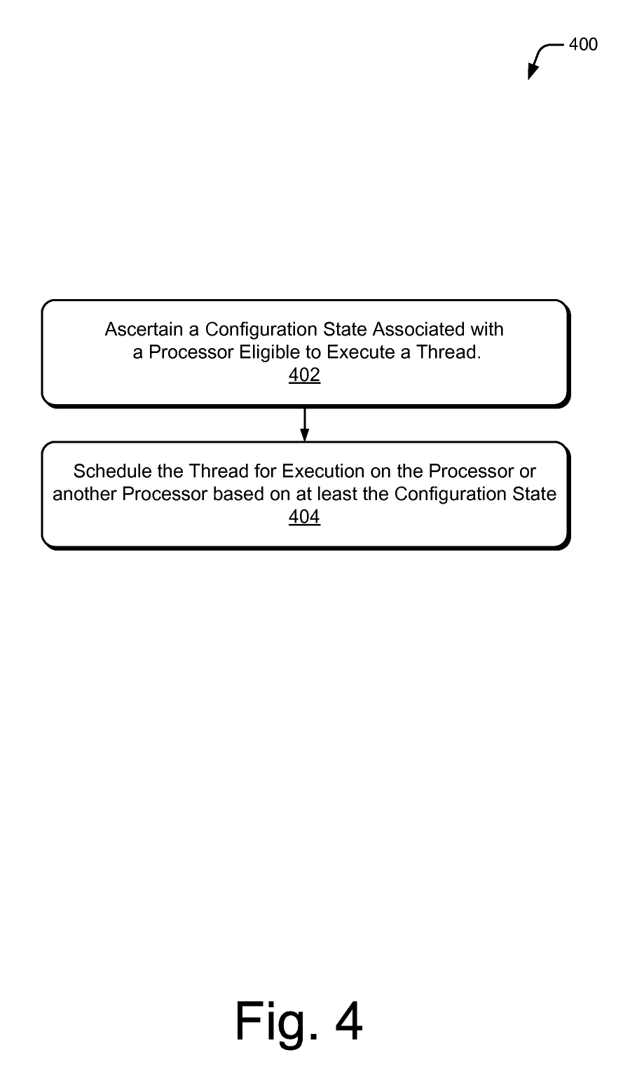

FIG. 4 is a flow diagram that describes steps in a method in accordance with one or more embodiments. These methods can be implemented in connection with any suitable hardware, logic circuitry, software, firmware, or combination thereof. In at least some embodiments, these methods can be implemented in connection with any systems or computing devices such as those described herein.

Step 402 ascertains a power configuration state of a processor. In at least some embodiments, the processor, or a core thereof, is eligible or available to execute a thread readied for execution. In some cases, the power configuration state may be a power configuration state defining a power configuration state at a processor package level, a processor die level, a processor core level, or a processor hardware thread level. In at least some embodiments, a thread scheduling entity may receive or maintain power configuration state information related to processors, processor packages, processor cores, or processor hardware threads. For example, thread scheduler 136 may receive information related to power configuration states of the cores 202, 204 of processor 114 from power manager 138. In some cases, the information related to power configuration states may comprise one or more bitmasks having bits that represent power configuration state information about a given processor. In such a case, thread scheduler 136 can calculate processor eligibility using a logical operation (e.g. AND, OR, or XOR).

In at least some embodiments, the power configuration state can be an idle configuration state or a performance configuration state managing operating characteristics of a processor or a core. In some cases, a latency value may be associated with a power configuration state defining an amount of time consumed by a processor to reach a thread-executable state. In other cases, an energy value may be associated with a power configuration state defining an amount of energy consumed by a processor to reach a thread-executable state.

Step 404 schedules the thread for execution on the processor or another processor based on at least the power configuration state. In at least some embodiments, the power configuration state can be a performance configuration state and scheduling the thread to execute on the processor or the other processor improves processing performance. Alternately or additionally, in at least some embodiments, the power configuration state can be an idle configuration state and scheduling the thread to execute on the processor or the other processor improves processing energy efficiency. For example, in the context of Table 2 and FIG. 3, thread scheduler 136 may schedule a thread for execution on core 310 instead of core 320 based on an idle configuration state of core 320. Scheduling a thread for execution on core 310 can save time and/or energy associated with bringing core 320 up to a thread-executable state.

In at least some embodiments, scheduling the thread for execution on the processor or another processor can be based on a latency value or energy value associated with the power configuration state. In some cases, a latency value or energy value may be associated with a power configuration state of a processor package or a processor die. For example, thread scheduler 136 may schedule a low priority thread for execution by core 310 to conserve energy based on an energy value associated with bringing core 320 and core processor 304 up to a thread executable state.

Alternately or additionally, in at least some embodiments, scheduling the thread for execution on the processor or the other processor can be based on a characteristic of the thread. The characteristic of the thread can be based on an execution history of the thread, an expected or average runtime of the thread, a processor affinity of the thread, or a frequency dependence of the thread. For example, a thread may be frequency agnostic until data associated with the thread is moved into an associated cache. In such a case, the thread may be scheduled on a processor having a low performance configuration state without adversely affecting processing performance.

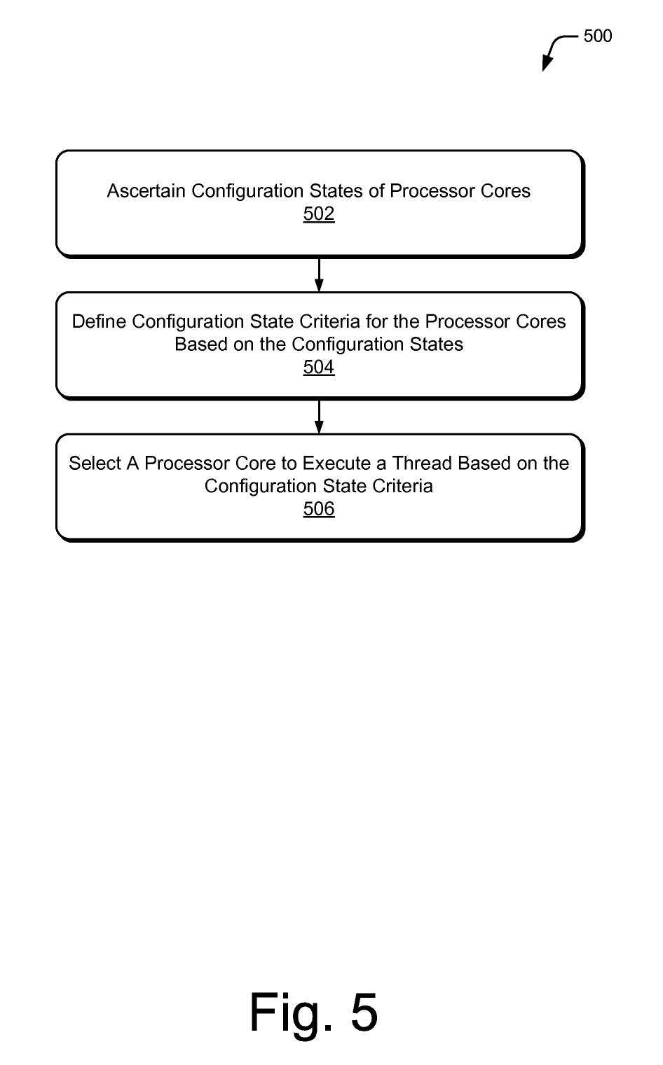

Next consider FIG. 5, which is a flow diagram that describes steps in a method in accordance with one or more embodiments.

Step 502 ascertains power configuration states of processor cores. Alternately or additionally, in at least some embodiments, the power configuration states can be associated with processors, processor packages, or processor dies. In at least some embodiments, information related to the power configuration states can be received from a processor state manager. In such a case, the processor state manager may be queried for information relating to the power configuration states of the processors. In other cases, a thread scheduler may be configured to maintain information relating to the power configuration states of the processors.

In at least some embodiments, the power configuration states of the processors are idle configuration states or performance configuration states. A processor core may be associated with multiple power configuration states. For example, core 320 of processor 304 may have a processor level power configuration state and a core level power configuration state as illustrated in Table 2.

Step 504 defines power configuration state criteria for the processor cores based on the ascertained power configuration states. In at least some embodiments, the power configuration state criteria can be based on energy efficiency or processing performance associated with the power configuration states of the processor cores. For example, processor cores having a deep idle configuration state may have configuration state criteria indicating substantial time or energy may be required to bring the processor core up to a thread-executable state. In other cases, a processor core having a high performance configuration state may have power configuration state criteria indicating the processor core is ready to execute a thread but wastes energy while idling or waiting for another thread to execute.

Step 506 selects a processor core to execute a thread based on the power configuration state criteria. In at least some embodiments, power configuration state criteria for two or more processors are compared when selecting a processor core. In some cases, indicated energy efficiencies are weighed against a thread priority to determine which processor core the thread is to be executed upon. Alternately or additionally, in at least some embodiments, selecting a processor core can be based on architectural dependencies of a processor core.

For example, in the context of Table 2 and FIG. 3, assume that each pair of cores (306 & 308; 310 & 312; 314 & 316; and 318 & 320) is frequency independent and voltage dependent. Thread scheduler 136 may determine that it is more efficient to serialize multiple threads on cores 306, 308 to allow the other cores to remain in deeper idle configuration states to conserve energy and improve a collective energy efficiency of computing device 102.

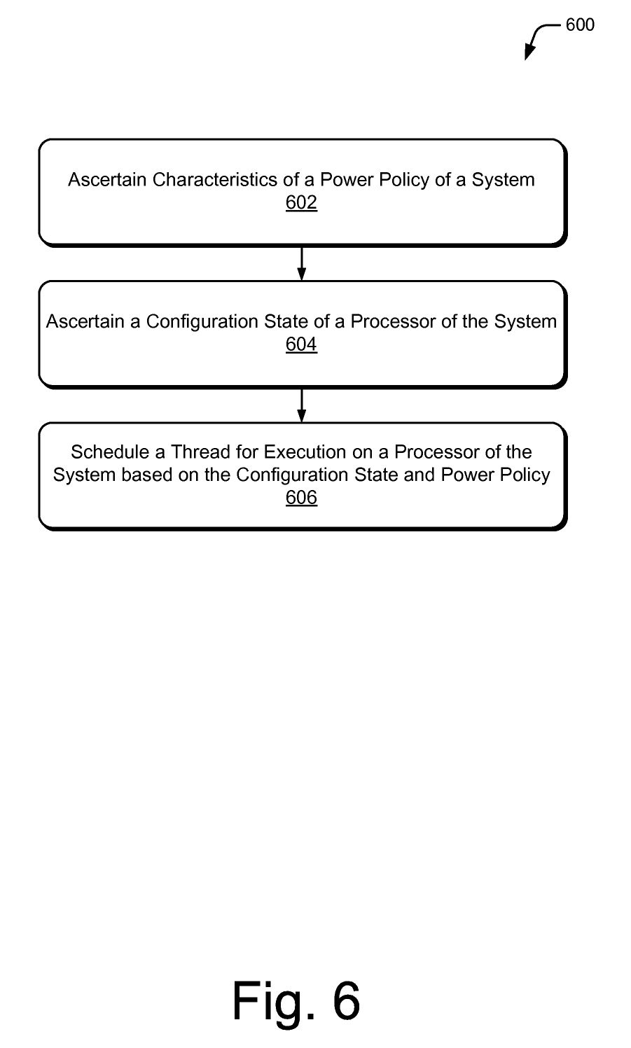

Now consider FIG. 6, which is a flow diagram that describes steps in a method in accordance with one or more embodiments.

Step 602 ascertains characteristics of a power policy of a system. In at least some embodiments, the power policy can be implemented by a power management entity or OS component. The power policy may be configurable by a manufacturer or user of the system to improve energy efficiency and/or to improve processing performance of the system. The power management entity may be implemented using software, firmware, hardware, or any combination thereof. For example, power manager 138 may implement a power policy for computing device 102 in accordance with a user selection of a predefined or customized power policy.

Step 604 ascertains a power configuration state of a processor of the system. In at least some embodiments the power configuration state may be an idle configuration state or a performance configuration state. The power configuration state may be defined or implemented in accordance with the ACPI specification, for example. Alternately or additionally, the power configuration state of the processor may be set in accordance with the power policy or may be based on other criteria, such as thread priority, current system loading, resources available to the processor (e.g. memory or bus bandwidth), and so on. In at least some embodiments, the power configuration state can be ascertained by a thread scheduling entity of a multi-processor or NUMA-based system.

Step 606 schedules a thread for execution on a processor of the system based on the power configuration state and the power policy. For example, thread scheduler 136 may consider a power policy of computing device 102, an idle configuration state of processor 114, or characteristics of a thread ready for execution when selecting a processor for executing the thread. In at least some embodiments, a power configuration state of a processor can be used to alter or weight a scheduling decision in order to align processor performance with the power policy. For example, when a power policy of the system is configured for performance, thread scheduler 136 may favor a processor having a high performance configuration state when scheduling threads to improve performance. Alternately, when a power policy of the system is configured for energy efficiency, thread scheduler 136 may favor a processor having a low performance configuration state or deeper idle configuration state when scheduling threads to improve energy efficiency.

Alternately or additionally, in at least some embodiments, scheduling a thread for execution may also be based on characteristics of the thread. For example, thread scheduler 136 implemented in a NUMA system can try to leverage a thread's history within NUMA nodes to attain improved cache hit rates, thus increasing performance. In the event that the NUMA nodes are occupied executing threads of equal or less priority, thread scheduler 136 can schedule a thread for execution based on the power configuration states of the NUMA nodes and other characteristics of the thread to be executed.

### CONCLUSION

Techniques for implementing processor state-based thread scheduling are described that improve processor performance or energy efficiency of a computing device. In one or more embodiments, a power configuration state of a processor is ascertained. The processor or another processor is selected to execute a thread based on the power configuration state of the processor. In other embodiments, power configuration states of processor cores are ascertained. Configuration state criteria for the processor cores are defined based on the respective power configuration states. One of the processor cores is then selected based on the power configuration state criteria to execute a thread.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claimed invention.

What is claimed is:

1. A method comprising:
ascertaining, for a processor eligible to execute a thread, a power configuration state associated with the processor; and
scheduling, based on at least the power configuration state, the thread for execution on the processor or another processor.

2. The method as recited in claim 1, wherein the power configuration state of the processor is an idle configuration state and wherein the scheduling of the thread for execution on the processor or the other processor improves a collective processing energy efficiency.

3. The method as recited in claim 1, wherein the power configuration state of the processor is a performance configuration state and wherein the scheduling the thread for execution on the processor of the other processor improves a collective processing performance.

4. The method as recited in claim 1 further comprising associating a latency value with the power configuration state, the latency value defining an amount to time consumed by the processor in order to reach a thread-executable state, and selecting the processor or the other processor to execute the thread based on the latency value.

5. The method as recited in claim 1 further comprising associating an energy value with the power configuration state, the energy value defining an amount of energy consumed by the processor in order to reach a thread-executing state, and selecting the processor or the other processor to execute the thread based on the energy value.

6. The method as recited in claim 1, wherein the power configuration state of the processor defines a power configuration state at a processor package level, a processor die level, a processor core level, or a processor hardware thread level.

7. The method as recited in claim 1 further comprising selecting the processor or the other processor for execution of the thread based on a thread characteristic.

8. The method as recited in claim 7, wherein the thread characteristic is based on an execution history of the thread, an expected run time of the thread, a processor affinity of the thread, or a frequency dependence of the thread.

9. One or more computer-readable media storing instructions that, when executed by a computing device, implement a thread scheduler configured to:
ascertain power configuration states of two or more processor cores;
define, for the two or more processor cores, a power configuration state criteria based on a respective power configuration state of each processor core; and
select, based on at least the power configuration state criteria, one of the two or more processor cores to execute a thread.

10. The one or more computer-readable media of claim 9, wherein the respective power configuration state of each of the processor cores is an idle configuration state or a performance configuration state.

11. The one or more computer-readable media of claim 9, wherein the two or more processor cores are implemented on a common package or a common die.

12. The one or more computer-readable media of claim 9, wherein the respective power configuration state of each of the processor cores is implemented in accordance with the advanced power and configuration interface (ACPI) specification.

13. The one or more computer-readable media of claim 9, wherein the instructions that, when executed by the computing device, implement a thread scheduler that is further configured to query a processor state manager for information associated with the power configuration states of the two or more processor cores.

14. The one or more computer-readable media of claim 13, wherein the information associated with the power configuration states of the two or more processor cores includes a data structure or bit mask.

15. The one or more computer-readable media of claim 9, wherein the instructions that, when executed by the computing device, implement a thread scheduler that is further configured to maintain information associated with the respective power configuration states of the processor cores.

16. A system comprising:
two or more processors configured to execute threads;
one or more computer-readable media configured to maintain one or more threads queued for execution;
a power manager configured to implement a power policy for the system;
a thread scheduler configured to:
ascertain characteristics of the power policy implemented by the power manager;
ascertain a power configuration state of one of the two or more processors; and
schedule the one or more threads for execution on the processor or another of the two or more processors based on the power configuration state and the characteristics of the power policy.

17. The system of claim 16, wherein the thread scheduler or power manager is embodied on the one or more computer-readable media.

18. The system of claim 16 further comprising logic circuitry and wherein the thread scheduler or power manager is implemented using the logic circuitry.

19. The system of claim 16 further comprising logic circuitry configured to manage the power configuration state of the processor and wherein the thread scheduler is further configured to query the logic circuitry for information associated with the power configuration state of the processor.

20. The system of claim 16, wherein the thread scheduler is further configured to select the processor or another of the two or more processors to execute the thread queued for execution based on thread performance characteristics.
